(19) United States
(12) Patent Application Publication
(10) Pub. No.: US 2011/0006263 A1
(43) Pub. Date: Jan. 13, 2011

(54) METHOD FOR MAKING HIGHLY EXFOLIATED VERMICULITE WITHOUT USING ANY ORGANIC BINDER OR ADDITIVE FOR FORMING THE SAME

(75) Inventors: Philippe Caplain, Sant Paul Trois Chateaux (FR); Herve Fuzllier, Essey-Les-Nancy (FR); Damien Hudry, Avignon (FR); Laurence Reinert, Saint Albin De Vaulserre (FR); Jean-Francois Juliaa, Montelimar (FR); Michel Lefrancois, Saint Etienne (FR)

Correspondence Address: Nixon Peabody LLP, P.O. Box 60610, Palo Alto, CA, 94306, US

(73) Assignee: COMISSARIAT A L'ENERGIE ATOMIQUE, Paris (FR)

(21) Appl. No.: 12/601,003

(22) PCT Filed: May 22, 2008
(86) PCT No.: PCT/EP2008/056329

§ 371 Date: Jun. 14, 2010

(30) Foreign Application Priority Data
May 23, 2007 (FR) 0755220

(51) Int. Cl. C04B 20/06

(52) U.S. Cl. 252/378 R

(57) ABSTRACT

A method for preparing an exfoliated vermiculite, comprising the following steps: (a) a step of heating a non-exfoliated hydrated vermiculite at a temperature extending from 400 to 600° C. for a period extending from 3 hours to 7 hours, in this way generating a dehydrated vermiculite; and (b) a step of contacting the dehydrated vermiculite with a solution containing an intercalating agent capable of decomposing while generating gases.

### CROSS REFERENCE TO RELATED APPLICATIONS OR PRIORITY CLAIM

This application is a national phase of International Application No. PCT/EP2008/056329, entitled “, METHOD FOR MAKING A HIGHLY EXFOLIATED VERMICULITE WITHOUT USING ANY ORGANIC BINDER OR ADDITIVE FOR FORMING THE SAME”, which was filed on May 22, 2008, and which claims priority of French Patent Application No. 07 55220, filed May 23, 2007.

### TECHNICAL FIELD

The present invention relates to a method for making a highly exfoliated vermiculite without the necessity of using an organic binder or organic additive for forming the same, these vermiculites having mechanical and chemical performances that do not deteriorate at the end of this method up to 1000° C.

Vermiculites are clays belonging to the family of phyllosilicates, namely silicates structured in the form of sheets. The structure of the sheets in the case of vermiculites is such that the sheets have a concertina-type form.

On account of this structure, vermiculites are capable of trapping a large quantity of air and naturally find an application in the field of thermal insulation. They may thus be used as a bulk insulator, notably in ceilings, or may be incorporated in construction materials such as cement or adhesives, in order to provide this insulating function.

One of the general fields of the invention is thus of thermal insulation.

### STATE OF THE PRIOR ART

One of the key materials in the field of thermal insulation has for many years been asbestos that is moreover characterized by a very high degree of non-flammability.

Asbestos is a calcium magnesium silicate with a fibrous nature that has the capacity of separating into microscopic particles that are likely to be inhaled and reach the pulmonary alveoli, or even the pleura, which makes this inhalation particularly pathogenic. Thus, the manufacture and marketing of asbestos has been prohibited in France since 1997.

Thus industrialists have considered replacing asbestos with other silicates that are not likely to split up into microscopic particles. This is the case notably of most of the phyllosilicates that no longer have the fibrous structure that asbestos has, but have a sheet structure.

More precisely, phyllosilicates represent a wide family of silicates in which SiO₄ tetrahedra are bound together and form infinite two-dimensional sheets and are condensed with MgO or AlO octahedra in a ratio of 2:1 or 1:1, some of these elements being able to be the subject of isomorphous substitution (it being possible for Si to be partly substituted by Al in tetrahedra, and for Al, Fe and/or Mg being able to occupy the same sites of the octahedra). The centers of the tetrahedra and octahedra are occupied by cations with a degree of oxidation of +4 or less than +4 (Si⁴⁺, Al³⁺, Mg²⁺), so that the charge on the sheet is negative.

When the tetrahedra and octahedra are condensed in a ratio of 2:1, this means in other words that, in a sheet, an octahedral layer is sandwiched between two tetrahedral layers (this structure being also called a “TOT-type stack”). Some of these 2:1 phyllosilicates, of which the loading of sheets calculated on a half-mesh lies between 0.6 and 0.9, are called vermiculites. A sheet is separated from another identical sheet by an interfoliar space occupied by hydrated cations (such as alkali metal, alkaline earth or ferric/ferrous cations), of which the positive charges compensate for the negative charges present on the surface of the sheets. These cations are bound to the sheets by weak bonds of the Van der Waals type.

On account of their structures in sheets and concertinas, vermiculites (if they are exfoliated), are particularly attractive in terms of thermal insulation, since this structure provides a considerable number of cells capable of trapping air. Moreover, it is possible, by applying suitable treatments, to carry out exfoliation of the sheets, namely a significant increase in the interfoliar distance that makes it possible to increase the capacity to receive air in this type of structure.

Various types of method for producing exfoliated vermiculite have been employed over the last few years.

Thus, an exfoliated vermiculite may be obtained by rapid heating between 800 and 1100° C., such as described by Meisinger in “Mineral Facts and Problems”, Vol. 675, 1985, ed. US department of the Interior Bureau of Mines Washington, pages 917-922. The mechanism is mechanical in origin. The sudden increase brings about vaporization of interfoliar water leading to separation of the sheets. This type of method is known under the name mechanical exfoliation. It allows the volume to increase by a factor of 12 to 18.

Other authors have carried out exfoliation of vermiculites by putting these into contact with an aqueous solution of hydrogen peroxide. The mechanism is based on the substitution of water molecules by hydrogen peroxide molecules (intercalation reaction). These latter, by decomposing in the interfoliar space in the form of oxygen or water, lead to a separation of the sheets. This type of method is known under the name chemical exfoliation. An increase in the volume of the particles is observed with expansion factors of 150 to 200.

WO 03004578 describes a vermiculite exfoliated by chemical means prepared in the following way:
a non-exfoliated crude vermiculite is first of all treated by contacting with a saturated aqueous solution of sodium chloride, in order to substitute magnesium ions and to create a homo-ionic vermiculite;
the homo-ionic vermiculite obtained in this way is contacted with a solution containing n-C₄—H₃NH₃ ions for replacing sodium ions by n-C₄—H₃NH₃ ions;
finally, the vermiculite is subjected to simple washing with water to complete exfoliation.

Forming these vermiculites is however only possible by using an organic binder of the polymeric type, which will ensure agglomeration of the vermiculite particles.

On account of the presence of this polymeric binder, the vermiculites described above, which undergo considerable modification of the structure above 300° C. and in this way lose their mechanical properties, may not be used in applications subject to temperatures above 450° C.

A real need thus exists for a simple method enabling a highly exfoliated vermiculite to be obtained that can be formed without the necessity of using an organic binder and that may be used in applications likely to be subject to temperatures that may extend to 1000° C.

### DESCRIPTION OF THE INVENTION

Thus, according to a first object, the invention deals with a method for preparing an exfoliated vermiculite comprising successively the following steps:
a step of heating a non-exfoliated hydrated vermiculite at a temperature extending from 400 to 600° C. for a period extending from 3 hours to 7 hours, in this way generating a dehydrated vermiculite;
a step of contacting the dehydrated vermiculite with a solution containing an intercalating agent capable of decomposing while generating at least one gas.

This step of heating within the aforementioned temperature and duration ranges is particularly important since it makes it possible to obtain optimum dehydration that is accompanied by separation of the sheets, in this way freeing the interfoliar space. The interfoliar space that is vacant in this way may receive the intercalating agent in an accelerated and optimum manner. Since the intercalating agent breaks down in the form of a gas, it will enable even greater separation of the sheets to occur due to release of these gases.

Moreover, on account of the optimum release of water molecules from the interfoliar space, the intercalating agent is contacted with the sheets without undergoing dilution by interfoliar water, which considerably increases the efficiency of this intercalating agent.

The non-exfoliated hydrated vermiculite that may be used as a starting vermiculite may be vermiculite in the form of flakes with an average length and width of the order of a centimeter, with a thickness generally less than a millimeter and having an interplanar distance measured by X-ray diffraction of the order of 12.1 Å. One of the vermiculites meeting these criteria is a vermiculite coming from the Palabora mine in South Africa.

As previously mentioned, the intercalating agent according to the invention is an agent capable of decomposing at least in the form of a gas. An extremely efficient intercalating agent according to the invention is hydrogen peroxide H₂O₂, which decomposes into H₂O and O₂, the release of oxygen contributing to the separation of the sheets and therefore to exfoliation.

From a practical point of view, contacting with a solution containing an intercalating agent generally consists of immersing vermiculites that have been previously dehydrated at 400° C. to 600° C. for 3 to 7 hours in said solution. Dehydrated vermiculites exhibit a reduction in their interplanar distance that tends towards a value of 10 Å reached for heat treatment at 800° C.

When the intercalating agent is hydrogen peroxide, the solution used may be a solution having a concentration extending from 35% to 50% by weight of hydrogen peroxide. This contacting step may be carried out at a temperature extending from 20 to 100° C., heating being notably strong in order to increase the rate of decomposition of the intercalating agent.

With such a hydrogen peroxide solution, whatever the concentration, significant swelling is already observable at the end of one hour's immersion for a vermiculite dehydrated at 400° C. for 7 hours, swelling reaching its maximum at the end of 12 hours immersion. Dehydration at 600° C. under the same conditions leads to maximum exfoliation in 1 hour. For these two pre-treatment temperatures, intercalation by hydrogen peroxide leads to the appearance of a vermiculite having an interplanar distance greater than, for example, 100 Å.

In both cases, the phenomenon is accompanied by spectacular swelling. The apparent volume of the vermiculite flakes is multiplied by a factor of around 600. When crude vermiculite (namely not having been subjected to heat treatment according to the invention) is immersed in hydrogen peroxide solution under similar experimental conditions as regards concentration and duration, an apparent volume increase is only visible at the end of 10 hours and is only complete at the end of 24 hours. Moreover, the volume observed is three times lower than for vermiculites having undergone thermal pre-treatment according to the invention.

This phenomenon of contacting a vermiculite with a solution of intercalating agent, such as H₂O₂, corresponds to chemical exfoliation.

The importance should be stated of not pretreating vermiculites thermally at a temperature exceeding 700° C., since within this temperature range vermiculites dehydrated in this way can no longer undergo chemical exfoliation with an intercalating agent, such as H₂O₂. Without being bound by any theory, this may be connected with a chemical modification of the ends of the sheets, elimination of hydroxyl groups causing the sheets to move together and their ends to condense, which considerably reduces accessibility and diffusion of molecules of intercalating agent.

The vermiculites obtained following the method of the invention advantageously have a specific surface extending from 100 to 220 m²·g⁻¹, the maximum being obtained for a sample of crude vermiculite heated first of all to 600° C. for 7 hours and immersed for 1 hour in a 50% hydrogen peroxide solution. Such a specific surface area results in a separation of the sheets into packets of approximately 7 to 8 units, the specific surface area of the crude vermiculite being approximately 10 m²·g⁻¹. The particles of exfoliated vermiculite generally have an average particle size extending from 6 μm to 50 μm. The finest particles are notably obtained when the chemical exfoliation treatment is coupled with an ultrasound treatment.

Thus, according to a second object, the invention deals with vermiculites capable of being obtained by a method as defined above.

The vermiculites obtained are malleable vermiculites, notably exhibiting mechanical properties of forming, compressibility and elastic recovery.

The vermiculites obtained may be formed by compression.

These vermiculites may be used in many fields, such as construction, insulation and coatings or for other more specific applications such as mechanical applications, for shock absorbing, light weight concretes, construction materials, fire protection, packaging materials for the conveyance of dangerous liquids, for producing solar thermal collectors and as nanocomposites for films and coatings.

According to a third object, the invention deals with a method for producing a compressed material comprising:
a step of putting into practice the method for preparing an exfoliated vermiculite as defined above; and
a step of forming the vermiculite obtained in the previous step, by compression, forming being advantageously performed in the absence of an organic binder.

The ability of a material in the form of flakes, such as vermiculites of the invention, of being able to be compressed, depends on two factors: particle size and water content.

Vermiculites obtained after the step of contacting with a solution of intercalating agent may be submitted, before the forming step, to a grinding step, preferably mechanical, it being possible to perform this step in a mortar, a cutting mill, a ball mill or by ultrasound, possibly followed by sieving, in order to select the granulometric fraction of particles with a size capable of being compressed easily. It may consist of particles with a size extending from 63 to 500 μm, obtained by grinding with mechanical grinders. It may also consist of particles with a size less than 10 μm, notably when grinding is carried out by ultrasound (for example at a frequency extending from 20 to 40 kHz).

The water content is also an important factor for forming vermiculites, water coming from the solution of intercalating agent and possibly the breakdown thereof.

In point of fact, there would be a risk that when a material containing residual water is formed, it will be subject to considerable shrinkage phenomena if it is submitted to applications involving exposure to high temperatures.

It may therefore be advantageous to submit vermiculites obtained by the method of the invention, after the step of contacting with a solution of intercalating agent or after any grinding step and before the forming step, to a step of heating at a temperature of 700 to 800° C. for a period that may extend from 1 to 14 hours (called the post-heating step).

Vermiculites may be subjected to compression in the form of a mixture comprising vermiculites that have undergone the step called post-heating as defined above, and vermiculites that have not been subjected to this step.

After any post-heating step and before the forming step, vermiculite in the form of particles may be subjected to a rehumidification step, for example by contacting said vermiculite with water, preferably distilled water, to a content that may extend from 0.2 mL to 0.5 mL per 100 mg of powder, for example a content of 0.25 mL per 100 mg of powder, water serving to facilitate the bond between vermiculite particles.

The vermiculite particles that have been formed are then dried at a temperature of 40° C. to 80° C. for a period that may extend from 12 hours to 24 hours, for example at 40° C. for 24 hours, in order to give a compressed dried formed material. The material after drying has mechanical properties that are decidedly better than those obtained by compressing dried vermiculite particles, namely particles not having been subjected to a rehumidification step.

Without being bound by any particular theory, water added in the rehumidification step would enable hydrogen bonds to form with —OH groups on the edges of the clay sheets, and of improving the stack of vermiculite particles during compression. During the drying step subsequent to the rehumidification step, hydrogen bonds created between the —OH groups at the edge of the sheet of vermiculite particles brought together in this way would enable the material to retain its mechanical properties.

In addition, and in place of the rehumidification step, provision may be made to contact the vermiculite in the form of particles with a solution called a “bridging solution” containing an element chosen from aluminum and silicon.

When the solution called the bridging solution is based on aluminum, it may be prepared by dissolving aluminum chloride (AlCl₃, 6H₂O) in distilled water at a concentration such that [Al³⁺]=0.2 mol·L⁻¹. The solution obtained is hydrolyzed by adding sodium hydroxide with stirring, the concentration of Off ions being equal to 0.2 mol·L⁻¹, addition being maintained until a molar ratio of OH⁻/Al³⁺ is obtained equal to 2. The resulting solution is then allowed to stand for 48 hours in a closed container at room temperature, until a sol is obtained containing the “Al₁₃⁷⁺” macrocation, resulting from polycondensation of the species in solution, it being possible for the time necessary for obtaining polycondensation to be determined by nuclear magnetic resonance of ²⁷Al. The sol is then added drop-by-drop to the vermiculite, possibly put into aqueous suspension (at a rate of for example 2.5% by weight), at a rate for example of 4.10⁻³ moles of aluminum per gram of clay. The resulting whole is left with stirring for 30 minutes at room temperature in order to enable the “Al₁₃⁷⁺ macrocation” to be grafted onto the edges of the sheets by fixing onto the surface —OH groups. After filtration and removal of chlorides by washing with water and drying (for example at 40° C. for 24 hours), the material may be easily formed by compression. Subsequent calcination (for example at 700° C. for 2 hours) enables the macrocation to be converted into alumina, providing cohesion between the sheets, which enables the formed material to have good strength.

In a general manner, the material thus formed may undergo a heating step at a temperature extending from 500° C. to 800° C., for example 700° C., and this to improve cohesion.

The invention will now be described in relation to the following example given as a non-limiting illustration.

### EXAMPLE

First of all, 2 g of “Large Grade” vermiculite were placed in a 250 mL beaker and were washed for 30 minutes with 100 mL of water purified by osmosis. The moist solid underwent dehydration by being placed suddenly at 400° C. in the oven for 7 hours in air in an alumina crucible. The dehydrated vermiculite was cooled to room temperature in a desiccator containing silica gel and was then exfoliated chemically by immersing in 100 mL of 35% by weight hydrogen peroxide for one hour. The product obtained was then dried in the oven at 40° C. for 14 hours and ground manually with a mortar.

Secondly, an aluminum-based bridging solution was prepared. To this end, an aluminum chloride solution with 0.2 mol·L⁻¹ of cations and a 0.2 mol·L⁻¹ sodium hydroxide solution were prepared by dissolving appropriate quantities of AlCl₃, 6H₂O and NaOH in distilled water. The sodium hydroxide solution was added drop-by-drop with stirring to the AlCl₃ solution until an OH/Al ratio was obtained equal to 2. The solution obtained was then aged at room temperature for 48 hours protected from any contamination and without mechanical agitation, so as to obtain the Al₁₃⁷⁺ macrocation.

Thirdly, the chemically exfoliated vermiculite was suspended in distilled water. The previously prepared bridging solution was added drop-by-drop with stirring so as to obtain 4 millimoles of aluminum per gram of vermiculite. The solution obtained was then stirred for 30 minutes at room temperature in order to homogenize the suspension and was then filtered. The vermiculite resulting from filtration was washed in order to remove chloride ions. The vermiculite obtained was then calcined for 2 hours at 700° C., in order to oxidize the aluminum cations. Manual grinding was then carried out in order to redisperse the agglomerates formed during calcination. Finally, the powders obtained were put into the form of pellets under a pressure of 180 bars with addition of water.

1. A method for preparing an exfoliated vermiculite comprising successively the following steps:
a step of heating a non-exfoliated hydrated vermiculite at a temperature extending from 400 to 600° C. for a period extending from 3 hours to 7 hours, in this way generating a dehydrated vermiculite;
a step of contacting the dehydrated vermiculite with a solution containing an intercalating agent capable of decomposing while generating at least one gas.

2. The method for preparing an exfoliated vermiculite as claimed in claim 1, characterized in that the intercalating agent is hydrogen peroxide.

3. The method for preparing a vermiculite as claimed in claim 2, characterized in that hydrogen peroxide is present in a solution at a concentration extending from 35% to 50% by weight.

4. The method for preparing an exfoliated vermiculite as claimed in claim 1, characterized in that the contacting step is carried out at a temperature extending from 20 to 100° C.

5. The method for producing a compressed material comprising:
a step of putting into practice the method for preparing an exfoliated vermiculite as defined in claim 1; and
a step of forming the vermiculite obtained in the previous step, by compression.

6. The method for producing a compressed material as claimed in claim 5, characterized in that the forming step does not require the use of an organic binder.

7. The production method as claimed in claim 5, including a step of grinding said vermiculite before the forming step.

8. The production method as claimed in claim 7, including, after any grinding step and before the forming step, a step of heating at a temperature extending from 700 to 800° C. for a period that may extend from 1 to 14 hours.

9. The production method as claimed in claim 7, including, after any heating step and before the forming step, a step of rehumidification with distilled water or of contacting with a solution called a “bridging solution” containing elements chosen from aluminum and silicon.

10. The production method as claimed in claim 5, comprising, after the forming step, a step of heating to a temperature extending from 500° C. to 800° C.
